(19) United States
(12) Patent Application Publication
(10) Pub. No.: US 2017/0244938 A1
(43) Pub. Date: Aug. 24, 2017

(54) Camera system with an automatic photo taking

(71) Applicant: Saad Al Mohizea, Riyadh (SA)

(72) Inventor: Saad Al Mohizea, Riyadh (SA)

(21) Appl. No.: 15/049,039

(22) Filed: Feb. 20, 2016

(51) Int. Cl. H04N 7/18; G06T 5/00; H04N 5/232

(52) U.S. Cl. CPC H04N 7/188; H04N 5/23241; G06T 5/003

(57) ABSTRACT

A photography system including a camera sensor, a controller in communication with the camera sensor, and a memory including instructions, that when executed by the controller, cause the controller to: upon receiving an input to begin a photographic mode, initiating a countdown timer, wherein the countdown timer lasts a timer duration; upon determining an interruption has occurred, modifying the timer duration; and, upon completion of the timer, capturing a photograph from the camera sensor.

### BACKGROUND OF THE INVENTION

The present subject matter relates generally to a camera system with an automatic timer. More specifically, the present invention relates to camera system that automatically begins taking photos in response to being turned on and automatically re-takes photos that are abnormal, such as insufficiently sharp.

Blurry or fuzzy photos are a common occurrence when taking pictures. A user may cause a photo to be blurry by failing to hold a camera sufficiently still when taking a photo. One cause of blurriness is the force of the user pressing a shutter button when taking a photo. On many modern cameras, such as smartphones, the low weight of the device and the elongated shape may cause camera shake in response to the simple act of pressing the shutter button. Accordingly, there is a need for cameras that reduce blurriness that may be caused by the user.

To deal with blurry or otherwise poorly taken photos, users often try to check on photos they've taken shortly after taking the photo. This may be a complicated process requiring unlaunching the camera application, launching the gallery, selecting the photo in question from a group of other photos, zooming in parts of the photo, and manually examining the photo quality. If the photo turns out to be of poor quality, the length of the review process may mean the moment to be captured has passed and taking a second photo is not an option. Accordingly, there is a need for cameras that can quickly take further photos after taking a first photo.

Another common problem when taking photos is caused when the user fails to take the photo before the moment to capture has passed. This problem is increasingly frequent due to camera phones that require the user to unlock the phone and launching the appropriate camera application before finally being able to take the photo by hitting the shutter button. Because of the time involved before the shutter button is pressed, the time to capture the event has passed.

Accordingly, there is a need for camera system that automatically begins taking photos in response to being turned on and automatically re-takes photos that are abnormal, as described herein.

### BRIEF SUMMARY OF THE INVENTION

To meet the needs described above and others, the present disclosure provides a camera system that automatically begins taking photos in response to being turned on, and that automatically re-takes photos that are abnormal, such as insufficiently sharp.

In one example, the camera device is special purpose (as opposed to a camera embedded in a multipurpose device such as a smartphone). In another example, the camera device is a smart phone including a camera application that may be executed by the smart phone camera device to provide the functionality described herein.

Normal operation of a camera proceeds in several steps: first the camera is turned on by pressing an ‘on’ button or launching a photo application; then, the user aims the camera at the object the user intends to photograph; and finally, the user presses a shutter button or switch to capture the photograph. Since the step of pressing the shutter or switch always follows the step of turning the camera ‘on’ or launching a photo application, it is desirable to reduce the time to take the photo before an interesting moment is gone.

Accordingly, in an embodiment, upon the camera device being turned ‘on’ or the camera application being launched, the camera device initiates a countdown timer 70. At the end of the timer, the camera device captures a photo.

The duration of the timer may be varied according to the user's preferences and whether most photos are still or moving objects, with the latter best timed with shorter timer durations. In an embodiment, a timer duration of about three seconds is enough for the user to aim correctly and hold still until the photo is taken. And, in some embodiments, once the timer is set to count down, the photo will be taken no matter what at the end of the timer, regardless of whether the scene to be taken has changed, the lighting condition has change or even a shake has been produced in the device.

However, in some embodiments, the timer may be delayed or cancelled by an interruption. Interruptions may be useful to prevent the camera device from taking a poor photo by having the camera device automatically detect poor photo conditions or change of user intent. Interruptions may be caused by one or more of the following: a change in the scene, device position or settings or any change in the users preference towards taking the photo, such as, zooming in or out or altering any setting or command in the camera device, such as moving the camera to another scene, shaking it, or turning the flash on.

In an embodiment, an interruption may cause the camera to cancel the countdown timer. In other embodiments, the timer may be extended or paused once an interruption is triggered, and thereafter the timer may resume once the interruption is over.

The camera device may additionally include functionality to check if a captured photo meets predefined quality criteria, and if it does not, to adjust the settings and retake the photo. For example, after a camera device may captures a photograph, the camera device may analyze the photograph along one or more characteristics, such as sharpness, noise, brightness, dynamic range, tone reproduction, color, distortion, red eye effect, vignetting, exposure accuracy, etc. The analysis may be done on one, some, or all of such characteristics.

Then, the camera may determine whether the photograph is abnormal. An abnormal photo may include any photo that is found to deviate from acceptable and standard measures of quality of a photo through subjective or objective means. For example, two common ways a photo may deviate from normal quality may include a lack of sharpness and over- or under-exposure.

In response to an abnormal photo, the camera device takes another shot right after the first one was deemed abnormal hoping that the event to be taken has not changed considerably. The camera device may then adjust its settings to correct the abnormality that was found. For example, if the photo was blurry, the focus settings may be changed. As another example, if the image was under-exposed, the exposure settings may be updated. The device may then repeat these steps until the captured photo is normal. For example, the camera device may return to the step capturing a photo or may initiate a timer for capturing a photo. Optionally and preferably, there could be a limit on how many attempts are done, for example, in an embodiment, three. In further embodiments, the limit may in the range of four or less, such as one, two, or three attempts.

In some embodiments, a timer to capture a second photo may be set only after a first photo is taken manually and found to be abnormal. For example, the user may click a take photo icon or press a shutter button to capture a photo. When the captured image is found to be abnormal, a countdown timer is set for a second take. Preferably, the duration of the timer is short so that the event to be taken has not changed since first take. The countdown timer may be preceded or accompanied by an alert in the form of a sound, vibration or visual indicator that the first image was abnormal and the timer is about to start for the second take. Alternatively, upon determining that a photo is abnormal, the camera device may alert the user that the photo that he or she has just taken is abnormal. The alert may be made by playing by a specific sound, displaying visual indicators, or vibrating in a pattern, etc. The user may then be given the choice to take another shot manually and not automatically.

When the camera device takes a photograph that is determined to be normal or abnormal, The photo may be associated with metadata that indicates that the photo is normal or lacking in abnormalities. The metadata may additionally include the analyzed characteristics.

An object of the invention is to provide a solution to the blurry or fuzzy photos that are a common occurrence when taking pictures. Moreover, the object of the invention is to reconfigure settings of camera based on a first image that turned out to be blurry and altering settings in millisecond time to take a sharper image again with the option of stalking photos complementing each other to produce one full sharp image.

An advantage of the invention is that it provides a camera device that may automatically take quality photos,

Another advantage of the invention is that it provides a camera device that minimizes blurriness caused by the user moving the device when pressing a shutter button.

A further advantage of the invention is that it provides a camera device that immediately and automatically retakes photos that are insufficiently blurry or otherwise abnormal.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is an example camera device.

FIG. 2 is a schematic diagram of another example camera device.

FIG. 3A is a flow chart illustrating an example countdown method that may be performed by the camera device.

FIG. 3B is an example frame of an image captured by the camera device including an artifact detected by the camera device.

FIG. 3C is another example frame of an image captured by the camera device illustrating the movement of the artifact within the frame.

FIG. 3D is an illustration of the movement of the camera device triggering an interruption.

FIG. 4, a quality photo method 400 is shown to take a photo that meets predefined quality criteria.

FIG. 5A illustrates an example of analyzing a photo by breaking the photo into a grid of squares 500.

FIG. 5B illustrates an example method for capturing an in-focus photo that may be executed by the camera device.

### DETAILED DESCRIPTION OF THE INVENTION

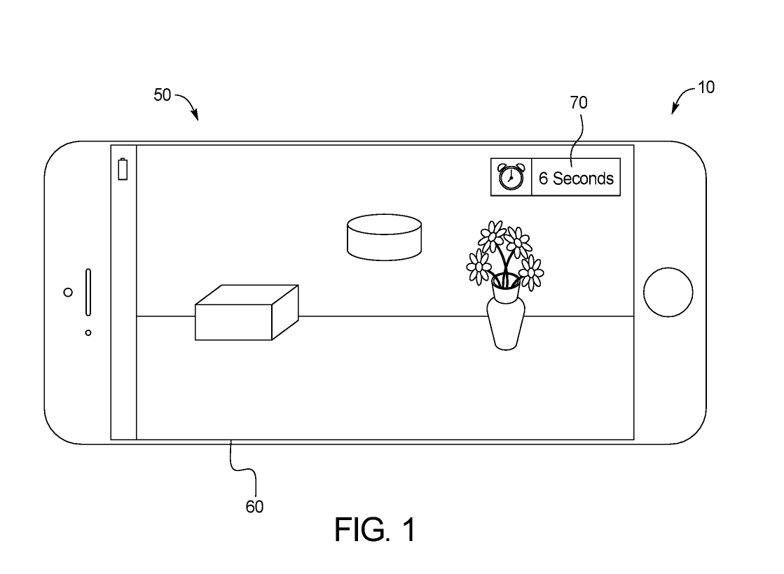

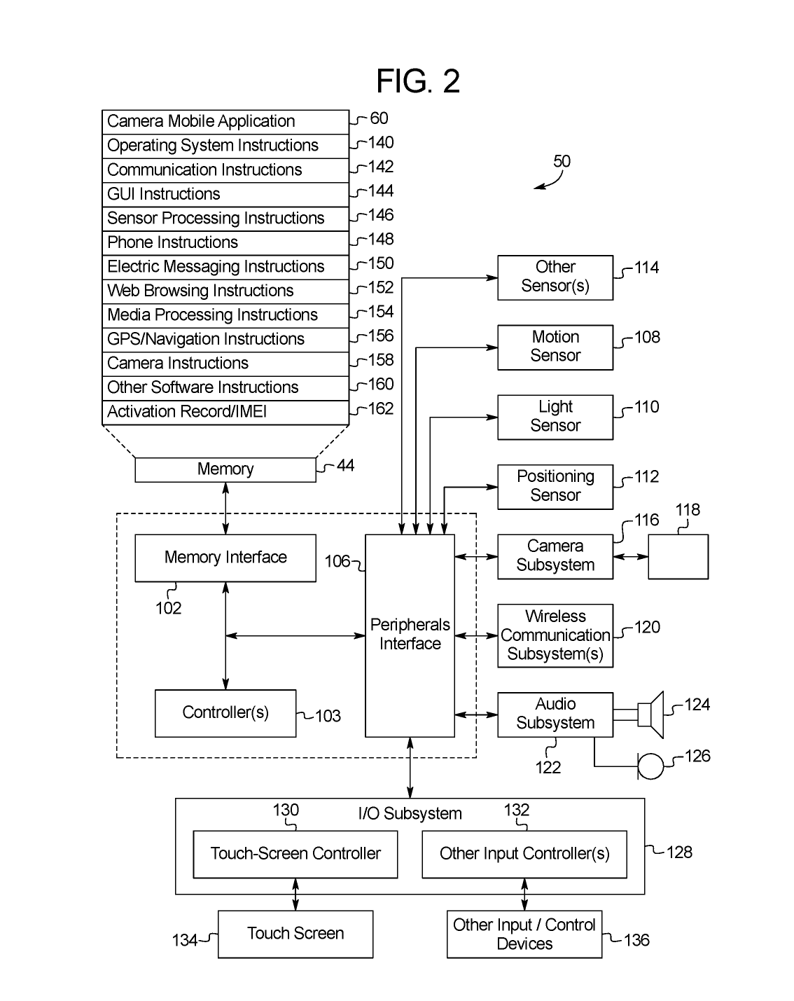

FIG. 1 illustrates an example of a camera device 10. As shown in FIG. 1, the camera device 10 may be a smartphone device 50 running a camera application 60 to provide the functionality described herein. FIG. 2 is a diagram illustrating the example components of an example of a camera device 10. As shown in FIG. 2, the camera device 10 may include a memory interface 102, controllers 103, such as one or more data processors, image processors and/or central processors, and a peripherals interface 106. A camera subsystem 116 and a camera sensor 118 (e.g., a charged coupled device (CCD) or a complementary metal-oxide semiconductor (CMOS) camera sensor) can be utilized to facilitate camera functions, such as capturing photographs and recording video clips.

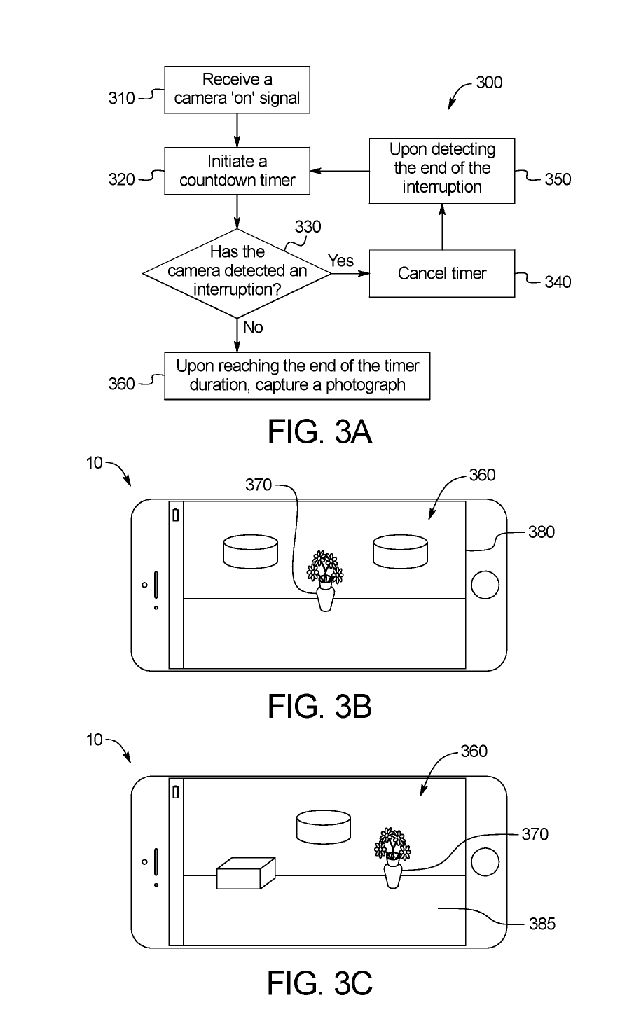

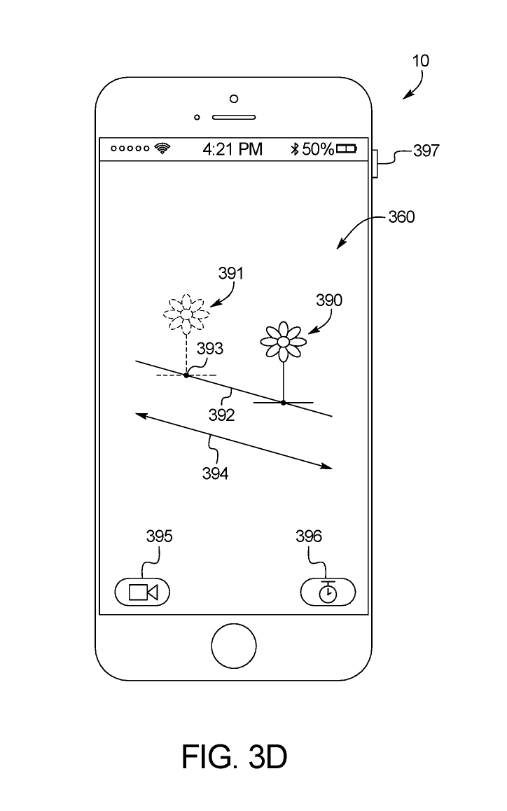

FIG. 3A illustrates a countdown anti-shake method 300 executed by a camera device 10 to reduce the risk of blurry and unfocused photos and take the photo as soon as possible. At a first step 310, the camera device 10 receives a camera ‘on’ signal. The camera ‘on’ signal may be received when the camera device 10 is powered on, for example, when the user presses a power on button. It is contemplated that, in some embodiments, the camera device 10 may include electronic circuits that are active even when the camera device 10 is not visibly ‘on’ to the user. For example, some camera devices 10 may include clock circuits, an ‘on’ button circuit, or other circuits that are powered whenever the device is connected to a power source, such as a battery. Accordingly, a camera ‘on’ signal is received when a user provides an input that activates the camera functionality.

In another embodiment, such as the embodiment of a camera device 10 in a smartphone device 50, the camera ‘on’ signal may be the activation of the camera application 60 by the operating system 140 upon the user pressing an application launch button for the camera application 60. Upon launching the camera application 60, the camera device 10 may continuously capture preview images from the camera sensor 118 and display the images on a screen 134.

At step 320, the camera device 10 initiates a countdown timer 70. The duration of the timer 70 may be pre-programmed, but may be varied according to the user's preferences and whether most photos 80 are still or moving objects, with the latter best timed with shorter timer durations.

It is believed that the average time needed to aim the camera device 10 to an interesting scene and then decide its nicely captured within the image frame is usually short. Additionally, in many cases, the photo 80 to be captured is an image of an event that might change or pass if too much time is wasted in clicking and pressing. Thus, in a preferred embodiment, a timer duration of about three seconds or less (for example, any fractional amount of seconds greater than two seconds but less than four) is provided. It is believed that this amount is considered enough for the user to aim correctly and hold still until the photo 80 is taken. In one embodiment, once the timer is set to count down, the photo 80 may be taken at the end of the timer, regardless whether the scene to be taken has changed, the lighting condition has change or even a shake has been produced in the device.

The duration of the timer 70 may be varied according to the scene. For example, a group selfie might need a duration that is greater than 4 seconds. In an embodiment, upon receiving a camera ‘on’ signal, the camera device 10 may capture one or more initial preview images of the screen. The initial preview images may then be analyzed to determine duration for the timer 70. The analysis may determine that the photo 80 to be taken meets a particular type, such as a selfie, a group selfie, a landscape photo, a daytime photo, a nighttime photo, etc. The timer 70 then may be set for a length of time set for photos 80 of that type. For example, if the camera device 10 detects a single person at close range to the camera in the preview images, the camera device 10 may determine that a single person selfie is being taken and set the timer to three seconds. As another example, the camera device 10 may detect multiple people at close range to the camera and determine that a group selfie is being taken and set the timer to eight seconds. As another example, the camera device 10 may determine a number of people in the initial preview image and set the timer 70 duration proportional to the number of people.

In some embodiments, the initial preview images may be analyzed to determine an amount of change between each initial preview image to determine a timer duration. For example, the initial preview images or other sensor data may be analyzed to determine the motion of the camera device 10. The timer duration may be set as a function of the motion of the camera, for example, the timer duration may be set proportionally to the speed of the camera device 10. (The speed of the camera device 10 may be it's relative motion to the scene, the rotation and/or translation of the camera as it is being moved into position, etc.) Alternatively, the speed of camera motion is below a threshold, a lower timer duration may used, for example, four seconds, while if the camera motion is above a threshold, a longer timer duration may be used, for example, six seconds.

Alternatively, in the embodiment of the countdown anti-shake method 300, the timer may be delayed or cancelled by an interruption. An interruption may be as any change in the scene, device position, settings, or any change in the users preference towards taking the photo such as, zooming in or out or altering any setting or command in the camera or phone. For example, by moving the camera device 10 to another scene, shaking it, or turning the flash on. Voice commands that have are accepted by the camera device 10, may additionally trigger an interruption if detected before the timer is up.

The interruptions can be categorized into two categories: those that have to do with the camera device 10, and those that have to do with the scene. The camera interruptions are those that happen due to a change in the position or settings of the camera device 10 whereas scene interruptions are those that are related to changes in the scene to be taken, such as movement of a person who is to be photographed away from the scene. For practical purposes, and for most scenarios, interruptions related to the camera device 10 are the ones should be relayed on and used as an indicator to cancel the timer. Recognizing scene changes as interruptions can be too inclusive and set a low threshold for taking photos of moving objects even when the phone is still and the intent is to take a photo 80 of such a scene. In specific situations where the intent is to take still scenes, interruption related to scene can be used as well.

At step 330, when, during the timer countdown, the camera device 10 detects an interruption, the camera device 10 may proceed to step 340 and cancel the timer 70. For example, detecting excessive shake may be regarded as an interruption and might signify that the camera device 10 has moved to another scene. Shake and camera movement may be recognized in many ways. For example, sensors, such as accelerometers, present in smart phones may used to detect shake. Preferably, slight shake or movements shouldn't be regarded as an interruption since such movement is common, and as long the scene to be taken is still largely within the frame of the screen the timer 70 shouldn't be interrupted. Thus, only if the shake exceeds a threshold will the shake trigger an interruption. For example, if the acceleration exceeds a threshold, or if the direction of acceleration is changing with a high frequency, the camera device 10 may determine that the amount of shake is excessive.

Alternatively rapid changes in the screen or viewfinder displayed from the camera sensor 118 may be interpreted as moving the camera device 10 to another location. The act of changing the position of the camera device 10 by the user usually indicates that the user has changed his or her mind and is aiming towards a different scene or wants to cancel altogether. Thus, the benefit of ending the countdown timer 70 in response to the movement of the camera device 10 is that it most likely reflects the desire of the user. In order to reflect the users intent, the camera device 10 may distinguish between motion caused by the user and motion caused by external factors (such as riding in a car). For example, in an embodiment, the camera device 10 may determine an interruption only when both the camera device 10 detects rapid changes in the screen or viewfinder and another input, such as acceleration detected by an accelerometer. In some instances, the detected acceleration may be a rotational acceleration as the user rotates the camera away towards a different scene.

For example, as shown in FIGS. 3B and 3C, a user may initially decide to take a photo of an outdoor scene 360. During the countdown, the camera device 10 may continuously capture photos 80 of the scene and monitor for changes. For example, the camera device 10 may capture in a first photo 380, the camera device 10 may use an reference point 370 in the first photo 380. In this example, the first point 370 is a flower. A short time later, the camera device may capture a second photo 385, shown in FIG. 3C. In the second photo 385, the user has changed the angle of aim and the reference point 370 is no longer in the center of the frame but at the edge of the frame. The camera device 10 may detect the movement of the reference point from the first photo 380 to the second photo 385, to determine a movement distance of the outdoor scene 360 as captured by the camera device 10. If the movement distance exceeds a predetermined amount, this may indicate a change of intent of the user and the camera device 10 may determine that an interruption has occurred.

To elaborate, as shown in FIGS. 3B and 3C, a user may initially decide to take a photo of an outdoor scene 360. During the countdown and if the scene 360 remains largely stable as the case in FIG. 3B and when the timer is up, a first photo 380 is automatically taken. However if there an alteration in captured scene as the case with FIG. 3C where the flower 370 was originally roughly at the center of the screen (FIG. 3B) and before the timer is up has been relocated towards the periphery of the screen (FIG. 3C) as a result of the user aiming at a different point, this is regarded as an interruption and the timer is either paused or canceled. The reason for this change happened because the user changed the angle of the camera device 10 and this signifies a new intent. In this example, if the new scene in FIG. 3C is held more or less stable after a new countdown is over the shot is then taken.

By interrupting the timer 70 upon movement of the camera device 10, the user may have some time to decide whether the newly captured scene 360 is what he would like to photograph and also enables the camera to have some time to readjust its settings. The distance beyond which a change in an artifact 370 is regarded as an interruption may depend upon on how far the object is estimated by the camera device 10 to be, but in general, a change of the position of center of the screen by more than one tenth of the screen diameter in the direction of the change (vertical, horizontal, and diagonal) may be used as the threshold for determining an interruption has occurred. the refernce point should be taken from the most important feature of the scene, like a face or objects at the middle of the screen.

In an embodiment, referring to FIG. 3D, shown is an illustration of the movement of the camera triggering an interruption. As shown in FIG. 3D, the position of the center 390 of the scene 360 (signified by a flower) at the time the timer starts counting is regarded as the reference point. At some point in time, the camera device 10 was moved and the center 390 of the screen (and the flower) moved to a new point 391. As discussed above, in an embodiment, a change of more than one tenth of the screen distance along the direction of movement line 394 is counted as exceeding the threshold. The nearest point 392 illustrates the one tenth of the screen distance limit. The direction of movement line 394 passes through the position of the displaced center 393.

The camera device 10 may continuously monitor the scene 360 from the time the timer starts until it ends, and at any time during this countdown if the center of the scene 360 moves and if this movement is above a predetermined threshold, the timer may be paused or canceled. Although the reference point of the center 390 of the screen in the provided example is the flower, it will be apparent to those of skill in the art that the reference point may be any other point in the image. A shift of the reference point means the whole scene has shifted as well by the same amount. In other embodiments, another way of detecting camera movement or shake is by using sensors such as gyroscopes or accelerometers.

Other interruptions may include an input by the user, loud audio inputs, etc. Those of skill in the art will understand that all, some, or only one of these interruptions may be configured to cancel the timer.

Yet another example of an interruption may include a change of the focus parameters of the camera device 10. In an embodiment, a camera device 10 may include camera instructions 158 that operate the camera subsystem 116 and a camera sensor 118, for example, for a camera device 10 embodied in a smartphone device 50 may include operating system level camera instructions 158 that may auto-focus the camera subsystem 116. The camera application 60 may monitor the focus parameters and when the focus parameters are changed beyond a predetermined level, the camera application 60 may trigger an interruption.

For example, if a user is trying to capture a flower, and after aiming for a few seconds and before the timer is up, decides to come closer the flower, this triggers changes in the auto focus settings. If the auto-focus changes exceed the predetermined level, the camera device 10 may trigger an interruption, causing the timer to be cancelled or otherwise modified as described herein. Likewise, other automatic changes of the cameras settings, such as ISO settings, lighting or flash settings, etc., by system level camera instructions 158 may trigger an interruption. Likewise, manual adjustments of these parameters may also be qualified as interruptions if above a certain threshold for that given parameter.

Motion sensors 108 may be used to detect movement, shake, vibration, orientation changes, etc., of the device in relation to a previous position may be used to trigger an interruption. Additionally, light sensors 110, positioning sensors 112 (such as GPS, cellular, or WiFi positioning), and other sensors 114 may be routinely monitored to detect readings outside of predetermined limits to trigger interruptions. Examples of sensors that may be included in the camera device 10 and used to trigger an interruption may include accelerometers, piezoelectric sensors, orientation sensors, magnetometers proximity sensor, gyroscopes, and rotational vector sensors. The light sensors 110 may be used to detect a change in the lighting of the scene to be taken to trigger an interruption.

In another embodiment, when the user decides to zoom in or out, this act may be regarded as an interruption and the timer cancelled until the zooming is over. Zooming may be accomplished by more than one mechanism, for example, clicking on the screen, pressing on a button, voice commands or even gestures may be used to zoom in and out to trigger the interruption. Gestures may be in the form of touch screen or pad gestures or aerial touchless gestures. Likewise, in some embodiments, zooming may be activated by shaking the phone, with position technologies in the camera device 10 recognizing its orientation and acting accordingly. For instance shaking the phone sideways may activate a zoom in while shaking it back and forth may activate a zoom out. Regardless to how zooming is performed, an extra second or two may added to the timer after zooming is over to provide an extra moment to correctly point the camera device 10 at the desired scene.

In another embodiment, the automatic countdown timer 70 may be started manually by the user pressing a timer switch 396 on a camera, or by pressing an appropriate icon on the camera application 60. The camera device 10 may additionally include a shutter button to trigger the capture of a photo. This gives the user different options of taking the photo rapidly and manually, or letting the automatic timer control the taking of a photo.

Just like taking photos, videos may be captured with an auto timer, with preferably shorter time durations. Optionally, a special button 395 or icon may be designated for taking videos instead of photos. The video would be recorded after the timer has ended, and in the case of videos, it may be configured such that it would start recording without being blocked by any interruption, since the nature of video taking dynamic and a lot of changes are expected.

In another variation, and to further speed the process of taking photos, the camera device 10 may include a special physical switch 397. When the camera device 10 is in an off mode, a user may press the special physical switch to both turn on the camera device 10 and launch the camera application 60 which may automatically take a photo 80 after a timer is up as described in FIG. 3A.

It is common to take a photo and discover later that the photo 80 is blurry or out of focus. Users often try to check on photos they've taken shortly after taking the photo 80. This may be a complicated process requiring unlaunching the camera application, launching the gallery, selecting the photo in question from a group of other photos, zooming in parts of the photo, and manually examining the photo quality. If the photo 80 turns out to be of poor quality, the length of the review process may mean the moment to be captured has passed.

It would be desirable to automatically determine if a photo 80 is below an acceptable threshold standard of quality and, if the photo is not of sufficient quality, automatically taking a second photo 80 while the user is still aiming his camera device 10 towards the scene. As will be described further below, the characteristics of the first photo may be used to automatically determine the most appropriate settings for a further shots.

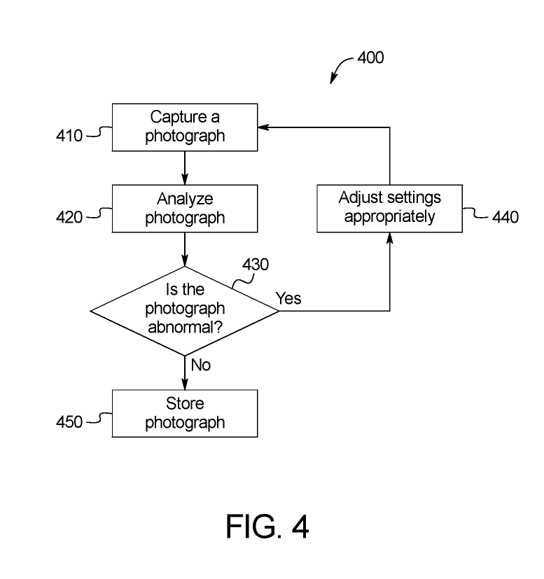

Referring to FIG. 4, a quality photo method 400 is shown to take a photo that meets predefined quality criteria, and if it does not, to adjust the settings and retake the photo. Starting at step 410, the camera device 10 captures a photograph. The photograph may be captured in response to a timer, or may be triggered manually by the user.

Next, at step 420, the camera device 10 may analyze the photograph along one or more characteristics, such as sharpness, noise, brightness, dynamic range, tone reproduction, color, distortion, red eye effect, vignetting, exposure accuracy, etc.

Then, at step 430, the analyzed characteristic is checked to determine whether the photograph is abnormal. As discussed below, if the photograph is found to be abnormal (for example, blurry), or if any one of the image characteristics is abnormal, then another photo may taken with or without changing the settings. For the purpose of this disclosure, an abnormal photo may include any photo that is found to deviate from acceptable and standard measures of quality of a photo through subjective or objective means. For example, two common ways a photo may deviate from normal quality may include a lack of sharpness and over- or under-exposure.

At step 440, in an embodiment, the camera device 10 adjusts settings to correct the abnormality. The settings of the camera device 10 may be modified to overcome the abnormality that was found. For example, if the photo was blurry, the focus settings may be changed. As another example, if the image was under-exposed, the exposure settings may be updated and or flash is used in the next take. The camera device 10 may then repeat these steps until the captured photo is normal. For example, the camera device 10 may return to step 410 to capture a second photo or may initiate a timer for capturing a second photo. Optionally and preferably, there could be a limit on how many attempts are done, for example, in an embodiment, three. In further embodiments, the limit may in the range of four or less, such as one, two, or three attempts. The camera device 10 may analyze all of the retakes and may choose the best shot and present it to the user. It will be understood by those of skill in the art that step 440 may be an optional step, as there may not be a need to adjust settings in certain situations.

In some embodiments, a timer to capture a second photo may be set only after a first photo 380 is taken manually and found to be abnormal. For example, the user may click a take photo icon or press a shutter button to capture a photo. When the captured image is found to be abnormal, a countdown timer 70 is set for a second take. The countdown timer 70 may be preceded or accompanied by an alert in the form of a sound, vibration or visual indicator that the first image was abnormal and the timer is about to start for the second take. Alternatively, upon determining that a photo is abnormal, the camera device 10 may alert the user that the photo that he or she has just taken is abnormal. The alert may be made by playing by a specific sound, displaying visual indicators, or vibrating in a pattern, etc. The user may then be given the choice to take another shot manually and not automatically.

At step 450, if the taken photograph is normal, the camera device 10 stores the photograph. The photograph may be stored in a photos folder. The photo may be associated with metadata that indicates that the photo is normal. The metadata may additionally include the analyzed characteristics. the user can be give the option whether to store abnormal photographs, with metadata describing that or have them automatically deleted.

It is important that the steps of analyzing the photo, adjusting the settings and retaking the photo is done within a short time, preferably less than two seconds. This is because the scene to be taken might change and/or the position of the device may change because of fatigue in the hands, for example. A second photo if taken immediately would be of a better quality and more natural than photos that are edited later on for imperfections.

A photo 80 may be analyzed for its quality of exposure by accumulating histograms. The peak value of these histograms are calculated and compared to a predefined standard value. A bad quality image in terms of exposure is when the peak value of the calculated histogram is beyond a predefined amount of the standard value, that is, in a position of a brighter side or a darker side out of the predefined amount of the standard value.

As for sharpness, traditionally, the most important part to consider if its sharp or not in the center of the photo, and or the part that was automatically or manually chosen to be the point of focus. That is, the user may touch the screen where focus is desired. With photos including people, faces are usually the intended point of focus, and faces detected in the photo may be analyzed for sharpness. By performing the analysis for sharpness at the point of focus and not the rest of the photo, a quality photo may be taken even though it is impossible to produces a photo that is sharp all around with one single shot, and thus the camera device 10 may produce photos that capture the part of the scene the most desired by the user as will be understood by those of skill in the art in the technical field.

In another variation, a photo may be broken into a grid of squares, and the analysis for sharpness may be calculated for each and every square. If one or more squares are found to be blurry, then the depth of field may be adjusted accordingly and more photos may be taken. Finally, the photos may be merged together by a technique know as focus stacking. Focus stacking may retain a large depth of field by merging several photos that were taken at different focusing distances producing one single, extended depth of field photo. The number of photos to be included when focus stacking may range from two to many. By focus stacking, a combined photo may be produced based on the sharpest regions from each of the separate photos.

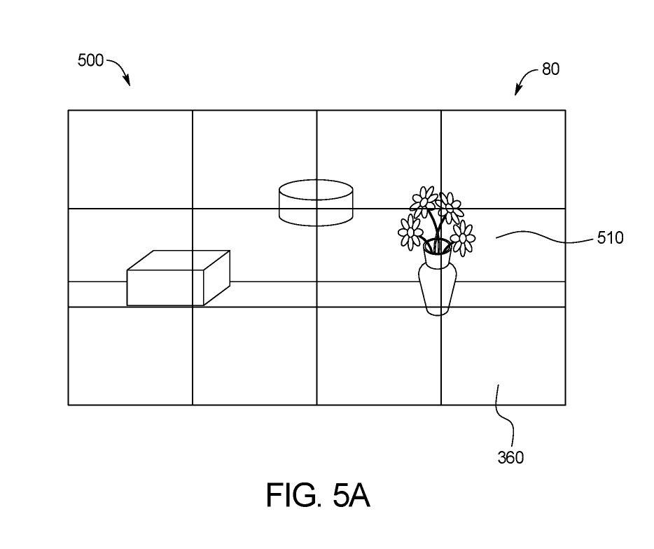

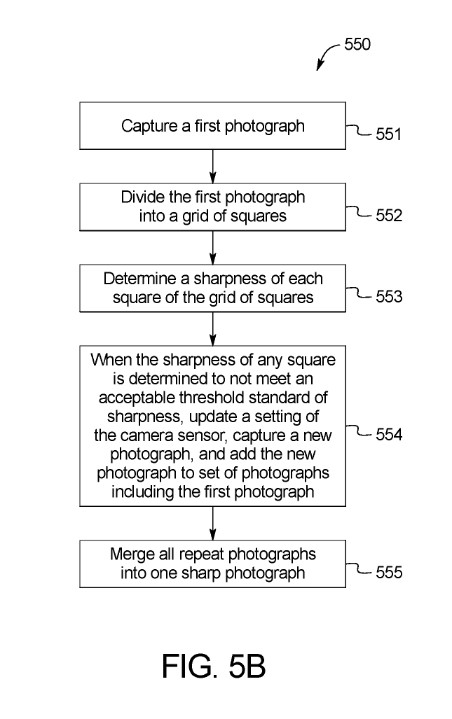

FIG. 5A illustrates an example of analyzing a first photo 380 by breaking the photo into a grid of squares 500. After capturing the first photo 380, the camera device 10 may split the photo into squares and each square 510 may be analyzed to determine the sharpness of that square. When a square 510 is determined to not meet an acceptable threshold of sharpness, the camera device 10 may calculate focus settings to improve the sharpness for that square. The camera device 10 may then capture an improved sharpness photo using the updated settings. The camera device 10 may repeat the process of updating settings and capturing improved sharpness photos to create a set of photographs in which each square 510 has a photo with an acceptable level of sharpness. Preferably, in an embodiment, the improved sharpness photos 385 are taken at incremental focal distances from near to far to further reduce the number of shots needed to improve sharpness. The camera device 10 may then merge the set of photographs with the first photo 380 to create a sharpened photo allover.

In an embodiment, the time between the capturing the first photo 380 and the improved sharpness photos may be immediately done to minimize the amount of changes in the scene 360 being captured. In an embodiment, each photo of the improved sharpness photos may be analyzed at each square 510 for sharpness. Each acceptable square 510 in an improved sharpness photo may be merged with the first photo without the need for taking a separate photo. In an embodiment, when merging the set of photographs, the squares with the correct level of sharpness may be substituted into the first photo to replace squares of insufficient sharpness.

FIG. 5B illustrates an example method 550 for capturing an in-focus photo that may be executed by the camera device 10. As shown in FIG. 5B, using the method 500, the camera device may: at step 551, capture a first photograph; at step 552, divide the first photograph into a grid of squares; at step 553, determine a sharpness of each square of the grid of squares; at step 554, when the sharpness of any square is determined to not meet an acceptable threshold standard of sharpness, update a setting of the camera sensor, capture a new photograph, and add the new photograph to set of photographs including the first photograph; and at step 555, merge the set of photographs into a single photograph.

In other embodiments, there are other techniques that may be used to determine if a photo 80 is blurry. For example, in one technique, sharp edges are used to generate a point spread function and the amount of image blur is estimated from this function. In another technique, the camera device 10 calculates the amount of image blur from the power spectrum of the photo in the frequency domain. In yet another technique, the camera device 10 applies a Laplace filter on the photo 80 and compare the maximum value across the photo to a predetermined value. If the maximum value exceeds the predetermined value, the entire photo may be found to be blurry.

Standard phones and cameras are equipped to continuously change settings as the scene in the screen changes to produce the best possible photos. However, even with these adjustments there is no guarantee that the photo produced is sharp and or of superior quality. By using the steps mentioned in FIG. 4, a camera device 10 may be reconfigured to always take a first “test” photo 380, where it gets analyzed for common characteristics such as sharpness and exposure, then, learning from the first shot, the settings may be adjusted accordingly to take the perfect shot. This should be done within a short duration (for example less than a second).

Referring back to FIG. 2, sensors, devices, and additional subsystems can be coupled to the peripherals interface 106 to facilitate various functionalities. For example, a motion sensor 108 (e.g., a gyroscope), a light sensor 110, and positioning sensors 112 (e.g., GPS receiver, accelerometer) can be coupled to the peripherals interface 106 to facilitate the orientation, lighting, and positioning functions described further herein. Other sensors 114 can also be connected to the peripherals interface 106, such as a proximity sensor, a temperature sensor, a biometric sensor, or other sensing device, to facilitate related functionalities.

Communication functions can be facilitated through a network interface, such as one or more wireless communication subsystems 120, which can include radio frequency receivers and transmitters and/or optical (e.g., infrared) receivers and transmitters. The specific design and implementation of the communication subsystem 120 can depend on the communication network(s) over which the camera device 10 is intended to operate. For example, the camera device 10 can include communication subsystems 120 designed to operate over a GSM network, a GPRS network, an EDGE network, a Wi-Fi or Imax network, and a Bluetooth network. In particular, the wireless communication subsystems 120 may include hosting protocols such that the camera device 10 may be configured as a base station for other wireless devices.

An audio subsystem 122 can be coupled to a speaker 124 and a microphone 126 to facilitate voice-enabled functions, such as voice recognition, voice replication, digital recording, and telephony functions.

The I/O subsystem 128 may include a touch screen controller 130 and/or other input controller(s) 132. The touch-screen controller 130 can be coupled to a touch screen 134, such as a touch screen. The touch screen 134 and touch screen controller 130 can, for example, detect contact and movement, or break thereof, using any of a plurality of touch sensitivity technologies, including but not limited to capacitive, resistive, infrared, and surface acoustic wave technologies, as well as other proximity sensor arrays or other elements for determining one or more points of contact with the touch screen 134. The other input controller(s) 132 can be coupled to other input/control devices 136, such as one or more buttons, rocker switches, thumb-wheel, infrared port, USB port, and/or a pointer device such as a stylus. The one or more buttons (not shown) can include an up/down button for volume control of the speaker 124 and/or the microphone 126.

The memory interface 102 may be coupled to memory 44. The memory 44 can include high-speed random access memory and/or non-volatile memory, such as one or more magnetic disk storage devices, one or more optical storage devices, and/or flash memory (e.g., NAND, NOR). The memory 44 may store operating system instructions 140, such as Darwin, RTXC, LINUX, UNIX, OS X, iOS, ANDROID, BLACKBERRY OS, BLACKBERRY 10, WINDOWS, or an embedded operating system such as VxWorks. The operating system instructions 140 may include instructions for handling basic system services and for performing hardware dependent tasks. In some implementations, the operating system instructions 140 can be a kernel (e.g., UNIX kernel).

The memory 44 may also store communication instructions 142 to facilitate communicating with one or more additional devices, one or more computers and/or one or more servers. The memory 44 may include graphical user interface instructions 144 to facilitate graphic user interface processing; sensor processing instructions 146 to facilitate sensor-related processing and functions; phone instructions 148 to facilitate phone-related processes and functions; electronic messaging instructions 150 to facilitate electronic-messaging related processes and functions; web browsing instructions 152 to facilitate web browsing-related processes and functions; media processing instructions 154 to facilitate media processing-related processes and functions; GPS/Navigation instructions 156 to facilitate GPS and navigation-related processes and instructions; camera instructions 158 to facilitate camera-related processes and functions; and/or other software instructions 160 to facilitate other processes and functions (e.g., access control management functions, etc.). The memory 44 may also store other software instructions controlling other processes and functions of the camera device 10 as will be recognized by those skilled in the art. In some implementations, the media processing instructions 154 are divided into audio processing instructions and video processing instructions to facilitate audio processing-related processes and functions and video processing-related processes and functions, respectively. An activation record and International Mobile Equipment Identity (IMEI) 162 or similar hardware identifier can also be stored in memory 44.

Each of the above identified instructions and applications can correspond to a set of instructions for performing one or more functions described herein. These instructions need not be implemented as separate software programs, procedures, or modules. The memory 44 can include additional instructions or fewer instructions. Furthermore, various functions of the camera device 10 may be implemented in hardware and/or in software, including in one or more signal processing and/or application specific integrated circuits. Accordingly, the camera device 10, as shown in FIG. 2, may be adapted to perform any combination of the functionality described herein.

Aspects of the systems and methods described herein are controlled by one or more controllers 103. The one or more controllers 103 may be adapted run a variety of application programs, access and store data, including accessing and storing data in associated databases, and enable one or more interactions via the camera device 10. Typically, the one or more controllers 103 are implemented by one or more programmable data processing devices. The hardware elements, operating systems, and programming languages of such devices are conventional in nature, and it is presumed that those skilled in the art are adequately familiar therewith.

For example, the one or more controllers 103 may be a PC based implementation of a central control processing system utilizing a central processing unit (CPU), memories and an interconnect bus. The CPU may contain a single microprocessor, or it may contain a plurality of microcontrollers 103 for configuring the CPU as a multi-processor system. The memories include a main memory, such as a dynamic random access memory (DRAM) and cache, as well as a read only memory, such as a PROM, EPROM, FLASH-EPROM, or the like. The system may also include any form of volatile or non-volatile memory. In operation, the main memory is non-transitory and stores at least portions of instructions for execution by the CPU and data for processing in accord with the executed instructions.

The one or more controllers 103 may further include appropriate input/output ports for interconnection with one or more output displays (e.g., monitors, printers, touchscreen 134, motion-sensing input device 108, etc.) and one or more input mechanisms (e.g., keyboard, mouse, voice, touch, bioelectric devices, magnetic reader, RFID reader, barcode reader, touchscreen 134, motion-sensing input device 108, etc.) serving as one or more user interfaces for the processor. For example, the one or more controllers 103 may include a graphics subsystem to drive the output display. The links of the peripherals to the system may be wired connections or use wireless communications.

Although summarized above as a PC-type implementation, those skilled in the art will recognize that the one or more controllers 103 also encompasses systems such as host computers, servers, workstations, network terminals, and the like. Further one or more controllers 103 may be embodied in a camera device 10, such as a mobile electronic device, like a smartphone or tablet computer. In fact, the use of the term controller is intended to represent a broad category of components that are well known in the art.

Hence aspects of the systems and methods provided herein encompass hardware and software for controlling the relevant functions. Software may take the form of code or executable instructions for causing a processor or other programmable equipment to perform the relevant steps, where the code or instructions are carried by or otherwise embodied in a medium readable by the processor or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as main memory of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a computer can read programming code and/or data. Many of these forms of computer readable media may be involved in carrying one or more sequences of one or more instructions to a processor for execution.

It should be noted that various changes and modifications to the presently preferred embodiments described herein will be apparent to those skilled in the art. Such changes and modifications may be made without departing from the spirit and scope of the present invention and without diminishing its attendant advantages.

1. A photography system comprising:
a camera sensor;
a controller in communication with the camera sensor; and
a memory including instructions, that when executed by the controller, cause the controller to:
upon receiving an input to begin a photographic mode, initiating a countdown timer, wherein the countdown timer lasts a timer duration;
upon determining an interruption has occurred, modifying the timer duration; and
upon completion of the timer, capturing a photograph from the camera sensor.

2. The photography system of claim 1, further including a power on button, wherein the input to begin a photographic mode is the activation of the power on button.

3. The photography system of claim 1, wherein the instructions are a portion of camera application, wherein the input to begin a photographic mode is the launch of the camera application.

4. The photography system of claim 1, including further instructions, that when executed by the controller, cause the controller to:
when the photograph is determined to not meet an acceptable threshold standard of quality, capturing immediately a second photograph from the camera sensor.

5. The photography system of claim 4, wherein immediately is a period of up to a half second.

6. The photography system of claim 4, wherein immediately is a period of up to two seconds.

7. The photography system of claim 1, wherein an interruption is triggered upon detecting a point of the scene leaving the frame of the screen.

8. The photography system of claim 1, wherein an interruption is triggered upon detecting a change in auto-focus parameters of the camera.

9. The photography system of claim 1, wherein an interruption is triggered upon using the zooming function of the camera.

10. The photography system of claim 1, wherein the step of modifying the timer duration is accomplished by canceling the timer.

11. The photography system of claim 10, including further instructions, that when executed by the controller, cause the controller to:
upon detecting an end of the interruption, initiating a second countdown timer; and
upon completion of the second countdown timer, capturing a photograph from the camera sensor.

12. The photography system of claim 1, wherein the step of modifying the timer duration is accomplished by pausing the timer.

13. The photography system of claim 12, including further instructions, that when executed by the controller, cause the controller to:
upon detecting an end of the interruption, resuming the timer countdown.

14. The photography system of claim 1, wherein, upon determining an interruption has occurred but before modifying the timer duration, the controller waits a predetermined period before modifying the timer duration, wherein, when the controller determines that the interruption is no longer present during the predetermined period, the controller refrains from modifying the timer duration.

15. The photography system of claim 1, wherein an interruption is triggered upon detecting a change in the position of the camera, wherein upon determining an interruption has occurred, capturing a second photograph from the camera sensor.

16. The photography system of claim 15, wherein the change in the position of the camera is detected by using one of a position sensor and a motion sensor.

17. A video photography system comprising:
a camera sensor;
a power supply;
a memory including camera instructions;
a controller in communication with the camera sensor and the memory, wherein the controller is adapted to be powered on upon receiving a power on signal, wherein upon being power on after receiving the power on signal, the controller executes the camera instructions;
a power on button in communication with the controller, wherein upon a user pressing the power button, the power on button communicates a power on signal to the controller;
wherein, the camera instructions, when executed by the controller, cause the controller to:
initiating a countdown timer, wherein the countdown timer lasts a timer duration; and
upon completion of the timer, begin capture of a video from the camera sensor.

18. A photography system comprising:
a camera sensor;
a controller in communication with the camera sensor; and
a memory including instructions, that when executed by the controller, cause the controller to:
capture a photograph; and
when the photograph is determined to not meet an acceptable threshold standard of quality, capturing a second photograph from the camera sensor.

19. The photography system of claim 18, wherein upon capturing the photograph, the controller analyzes the photograph to determine at least one setting to update, wherein the controller updates the setting before capturing the second photograph.

20. The photography system of claim 18, wherein the photograph is determined to not meet an acceptable threshold standard of quality when a level of blurriness of the photograph exceeds a threshold, wherein the controller is further adapted to:
generate a point spread function from the sharp edges of the photograph,
calculate the level of blurriness from the point spread function,
when the level of blurriness exceeds the threshold, capture a second photograph from the camera sensor.

21. The photography system of claim 18, wherein the photograph is determined to not meet an acceptable threshold standard of quality when a level of blurriness of the photograph exceeds a threshold, wherein the controller is further adapted to:
generate a power spectrum of the photo in the frequency domain,
calculate the level of blurriness from the power spectrum, and
when the level of blurriness exceeds the threshold, capture a second photograph from the camera sensor.

22. The photography system of claim 18, wherein the camera analyzes the photo for one of the group consisting of sharpness, noise, brightness, dynamic range, tone reproduction, color, distortion, red eye effect, vignetting and exposure.

23. A photography system comprising:
a camera sensor;
a controller in communication with the camera sensor; and
a memory including instructions, that when executed by the controller, cause the controller to:
capture a first photograph;
divide the first photograph into a grid of squares;
determine a sharpness of each square of the grid of squares;
when the sharpness of any square is determined to not meet an acceptable threshold standard of sharpness, update a setting of the camera sensor, capture a new photograph, and add the new photograph to set of photographs including the first photograph; and
merge the set of photographs into a single photograph to produce a sharp photograph.
